(19) United States
(12) Patent Application Publication
(10) Pub. No.: US 2008/0010538 A1
(43) Pub. Date: Jan. 10, 2008

(54) Detecting suspicious embedded malicious content in benign file formats

(75) Inventors: Sourabh Satish, Fremont, CA (US); Brian Hernacki, San Carlos, CA (US)

Correspondence Address: MEYERTONS, HOOD, KIVLIN, KOWERT & GOETZEL, P.C., P.O. BOX 398, AUSTIN, TX, 78767-0398, US

(73) Assignee: SYMANTEC CORPORATION

(21) Appl. No.: 11/475,664

(22) Filed: Jun. 27, 2006

(51) Int. Cl. G06F 11/00

(52) U.S. Cl. 714/38

(57) ABSTRACT

A method and system for detecting suspicious embedded malicious content in benign file formats is disclosed. The method involves loading a benign data file type and performing a sectional disassembly to detect if the file contains any encodings that are machine code instructions that, when executed by a microprocessor, would result in a transfer of process control. The method may be implemented in two stages: in a first stage to detect the presence of any encodings representing logical instructions; and in a second stage to analyze the maliciousness of the detected encodings. In addition to protecting computer systems from a specific exploit, the method may be used for certifying a file clean of malicious code, or for detecting vulnerabilities targeted at application programs.

### BACKGROUND OF THE INVENTION

1. Field of the Invention

This invention relates to the field of information processing systems and, more particularly, to protecting information processing systems from malicious content.

2. Description of the Related Art

Information processing system security (including network security) is very important today for preventing attacks launched by hackers with sinister intentions, particularly when the computer and network are connected to the Internet or other untrusted network. These attacks can be in the form of computer viruses, worms, denial of service, improper access to data or other kinds of malicious software. Malicious software or code is typically designed to launch an attack on a host system by exploiting certain vulnerabilities in the system (or network); hence such threats are also generally referred to as exploits.

Intruders to information processing systems are increasingly skilled at exploiting weaknesses to gain access and unauthorized privileges, making it difficult to detect and trace such attacks. Moreover, security threats from malicious software, such as viruses, worms, or other exploits, may propagate without human supervision and are capable of replicating and traveling to other networked systems. In particular, the introduction and propagation of malicious software within an organization or its network can cause the damage to increase exponentially in a short time, which correspondingly can cause incapacitation of client computers, network infrastructure, and network servers. This can ultimately result in a shutdown of business-critical operations and large economic losses from downtime and lost productivity. The commercial damage by exploits includes all efforts required to contain the malicious software and extensive labor resources required to perform repairs and restoration. Therefore, early detection of exploits and prevention of attacks are critical aspects in security efforts.

Previously known types of malicious code were often associated with data comprising executable code that provided a pathway for the exploit to execute malicious instructions on a microprocessor. Until recently, many types of data files, which were not expected to contain any executable instructions, were considered benign in terms of their ability to introduce an exploit. For example, a JPEG file containing a digital image was previously not considered a risk for introducing exploits, since the applications that open and load JPEG data files were not considered vulnerable to exploits. It was also not generally known that malicious instructions embedded in such benign files could be forced to execute, and even transfer execution control.

Recently, however, many vulnerabilities have been discovered that arise from functionality in applications performing specific logic while handling so called ‘benign’ data file types. These vulnerabilities effectively make most benign data file types the source of the exploit. Examples of widespread vulnerabilities that have been recently exploited to deliver malicious code include applications that load the JPEG and WMF data file formats. The term ‘data file’ generally refers to a file which does not contain executable instructions for a microprocessor, but contains merely a payload of raw data. A benign type of data file is a type of data file in which the presence of executable code is normally not expected, or in which executable code does not serve any logical purpose in relation to the data content of the file.

These kinds of data file exploits have been found to involve two steps. First, the exploit is packaged in the data file type and delivered to the target user. Second, the target user has to either load that data file type in the corresponding application, or the application has to be capable of automatically processing the data file to trigger the exploit execution. Conventional security systems are often not configured to check benign data files to determine if they are possibly carrying any malicious exploit code.

A conventional method for loading a data file by an application program involves determining the file type of the data file. One common method for determining the file type is by examining the file extension portion of the name of the data file. The file extension is typically a three character alphanumeric code following a period sign, for example “.doc” for MS-Word documents, or “jpg” for JPEG files, or “.wmf” for Microsoft Windows Metafiles, etc. The file extension may also be more than three alphanumeric characters, such as “.html” for a Hypertext Markup Language file.

Once the file type of the data file is known, the data file may be manually loaded by selecting the file within the application program, or may also be automatically loaded by selecting the data file for opening, and having an association registered in the system to a particular application program, which receives the file for loading. Note that an application loading a data file into memory generally does not filter or discriminate which data files to load, other than by the file type. For the case of a benign type data file containing embedded or malicious executable code, once the application loads the file into memory, the malicious code is also loaded into memory and may manifest itself as an exploit. Depending on how the malicious code has been embedded in the data file, a vulnerability in the application program may result in execution control being passed to the malicious code. Thus, without a method for detecting the presence of executable code in data files, a vulnerability for exploits exists for applications that load data files of a benign type.

It is noted that some audio visual technologies and virus detection programs may scan data files independent of the file type, but merely for known viral patterns. However, the exploit mechanism in the kinds of data file exploits described above has not involved viral signatures, but has been specific to the application loading the data file on the given platform. Therefore, conventional methods of detecting malicious code (also referred to as a scan) are not effective in recognizing these new kinds of benign data file exploits and are unable to prevent the corresponding application from loading and delivering the exploit.

### SUMMARY OF THE INVENTION

Various embodiments of a method for detecting malicious code are disclosed. In one embodiment, a method comprises disassembling a data file, wherein the data file is a benign type of data file, wherein the disassembling includes searching said data file for one or more encodings corresponding to executable code; and designating the data file as suspicious in response to detecting one or more encodings corresponding to executable code in the data file. In one embodiment, the method further comprises making a determination whether the one or more encodings corresponding to executable code would result in a transfer of process control when executed; and designating the data file as malicious in response to said determination being positive. A benign type of data file may include any one of: JPEG files; WMF files; HTML files; text files; audio data files; image data files; video data files; and any type of data file whose format does not specify the inclusion of executable code. The one or more encodings corresponding to executable code may include machine code instructions for causing a microprocessor to perform any one of: load a variable; jump to a register; jump to a location in memory; jump to an instruction; generate an interrupt; call a procedure; switch to a different task; and invoke any operating system API procedure. The one or more encodings corresponding to executable code may include one or more operational codes of a microprocessor and may also include operands associated with the operational codes. In one embodiment, the one or more encodings corresponding to executable code include one or more machine code instructions detected by matching one or more entries in a reference table of machine code instructions.

Other embodiments are also disclosed, such as an information handling system including a memory, a first processor, and computer-readable code stored on said memory and processable by said first processor for implementing detection of malicious code said computer-readable code including instructions for causing said first processor to disassemble a data file, wherein the data file is a benign type of data file, wherein the disassembling includes searching said data file for one or more encodings corresponding to executable code; and designate the data file as suspicious in response to detecting one or more encodings corresponding to executable code in the data file. In one embodiment, the system further includes instructions for causing said first processor to make a determination whether the one or more encodings corresponding to executable code would result in a transfer of process control when executed; and designate the data file as malicious in response to said determination being positive. In one embodiment, the one or more encodings corresponding to executable code may include machine code instructions for causing a second microprocessor to perform any one of: load a variable; jump to a register; jump to a location in memory; jump to an instruction; generate an interrupt; call a procedure; switch to a different task; and invoke any operating system API procedure. The one or more encodings corresponding to executable code may include one or more operational codes of a second microprocessor. In one embodiment, said first processor and said second microprocessor are the same processor. In another embodiment, said first processor is implemented as an embedded controller in a network device, wherein the data file is disassembled from a stream of network packets representing the data file in transit. The embedded controller may be an FPGA.

Another embodiment is represented by a computer readable medium including program instructions executable to detect malicious code according to the methods described herein.

### BRIEF DESCRIPTION OF THE DRAWINGS

FIG. 1 is a block diagram of one embodiment of a computer system.

FIG. 2 is a diagram of a malicious code detection in one embodiment.

FIG. 3 is a flow chart illustrating a method in one embodiment.

While the invention is susceptible to various modifications and alternative forms, specific embodiments are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the spirit and scope of the present invention as defined by the appended claims.

### DETAILED DESCRIPTION

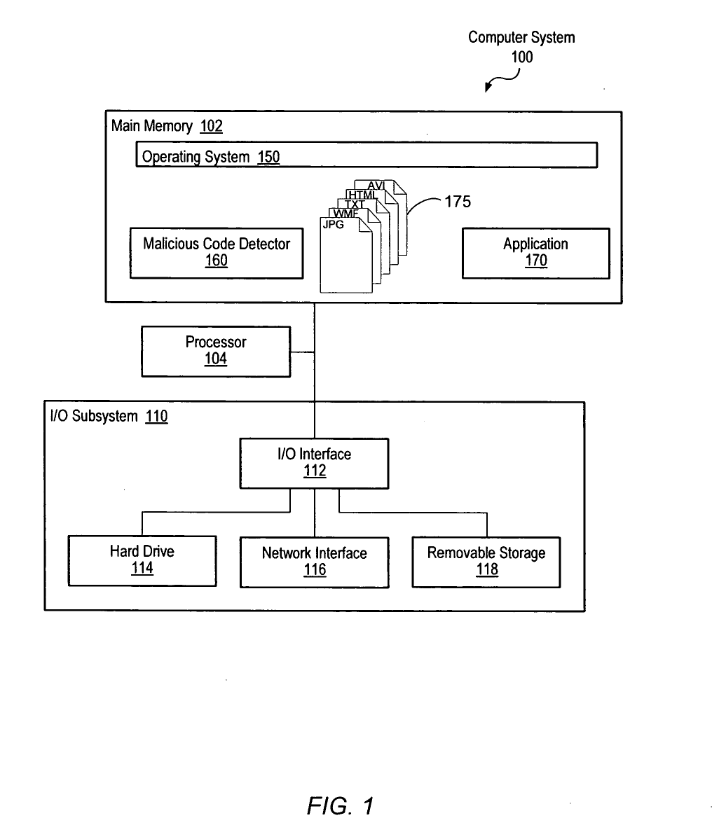

Referring to FIG. 1, a block diagram of one embodiment of a computer system 100 is illustrated. Computer system 100 includes a processor 104 coupled to a main memory 102. Processor 104 and main memory 102 are in turn connected to an I/O subsystem 110, which comprises an I/O interface 112, a hard disk drive 114, a network interface 116, and a removable storage 118. Computer system 100 may be representative of a laptop, desktop, server, workstation, terminal, personal digital assistant (PDA) or any other type of computer system.

Processor 104 is representative of any of various types of processors such as an x86 processor, a PowerPC processor or a SPARC processor. Similarly, main memory 102 is representative of any of various types of memory, including DRAM, SRAM, EDO RAM, Rambus RAM, etc.

I/O interface 112 is operational to transfer data between processor 104 and/or main memory 102 and one or more internal or external components such as hard disk drive 114, network interface 116 and removable storage 118, as desired. For example, I/O interface 112 may embody a PCI bridge operable to transfer data from processor 104 and/or main memory 102 to one or more PCI devices. I/O interface 112 may additionally or alternatively provide an interface to devices of other types, such as SCSI devices and/or Fibre channel devices.

Hard disk drive 114 may be a non-volatile memory such as a magnetic media. Network interface 116 may be any type of network adapter, such as Ethernet, fiber optic, or coaxial adapters. Removable storage 118 is representative of a disk drive, optical media drive, tape drive, or other type of storage media, as desired.

In addition to the various depicted hardware components, computer system 100 may additionally include various software components. For example, FIG. 1 illustrates an operating system 150 stored in main memory 102. Operating system 150 is representative of any of a variety of specific operating systems, such as, for example, Microsoft Windows, Apple Mac OS, Linux, or Sun Solaris. As such, operating system 150 may be operable to provide various services to the end user and provide a software framework operable to support the execution of various programs such as application 170. It is noted that the depicted software components of FIG. 1 may be paged in and out of main memory 102 in a conventional manner from a storage medium such as hard drive 114.

As will be described in further detail below, malicious code detector 160 represents a software module configured to execute a method for detecting malicious code in the form of embedded machine code in a benign type data file. Application 170 represents one embodiment of an application program capable of opening or loading a data file according to the methods described herein. Computer system 100 may also include one or more data files 175, of which at least some may be benign type data files, in which malicious code may be embedded.

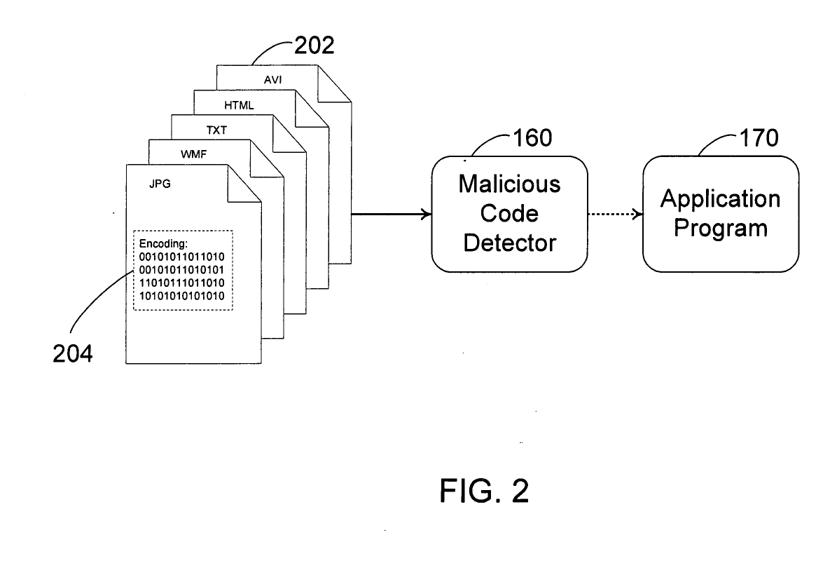

Referring to FIG. 2, a diagram of aspects associated with one embodiment of malicious code detector 160 is illustrated. A plurality of benign type data files, as discussed above, is represented by 202. It is noted that the binary form of each data file includes a series of binary patterns, or encodings 204, which may correspond to valid instructions (i.e., operating codes) for a microprocessor, if an exploit has been maliciously embedded in the file. Each data file 202 may be processed by a malicious code detector 160, whose operation will be described in detail below. In various embodiments, the malicious code detector 160 may include methods specific for a given application and/or for a given microprocessor, for example processor 104. In one example, malicious code detector 160 may include routines for determining the application program 170 loading a file 202, the microprocessor (i.e., type of processor 104) executing the application program 170, and the operating system 150 running application program 170. It is noted that malicious code detector 160 may then select and execute one or more detection methods, which are specific to the data file type 202, the application program 170, the operating system 150, or the microprocessor 104.

Since a benign type of data file is a data file in which the presence of executable code is not expected under any normal circumstances, or in which executable code does not serve any logical purpose in relation to the data content of the file, the presence of any encoded executable code in a benign file type data file may be interpreted as an indication of the file being at least suspicious, if not malicious. The presence of encoded machine code instructions in a benign file type of data file, which, when executed by a microprocessor, would result in a transfer of process control, may also be interpreted as an indication of the file containing malicious code.

It is noted that there is a finite statistical probability for finding a single encoding 204 corresponding to a machine code instruction in a benign data file. However the probability of finding a set of encoded machine code instructions (including any associated operands) in a benign type data file that does not contain embedded malicious code can be assumed sufficiently small enough to preclude false positives in detecting malicious code.

As shown in FIG. 2, the methods described herein for detecting malicious code are performed before the potentially vulnerable application program 170 opens or loads the file for processing. In some embodiments, it is possible that, as sections of a file have been scanned and declared clean, the application can possibly open the file and only read the scanned sections of the file, while the scan continues on the remaining sections. In other embodiments, a file may be scanned in transit over a network, such that the data packets representing the file are subverted and analyzed in a network device, which may be an interface controller, a router, a gateway, a bridge, or a network switch.

The methods described herein involve various embodiments for detecting malicious code by analyzing the contents of a data file. One aspect of an implementation includes checking a benign data file type for suspicious executable content. Another aspect of an implementation is checking the data file in a manner causing minimal performance impact, because some operations involved with a thorough analysis may require substantial computational processing power. One implementation that addresses each of these aspects is embodied by a two stage detection, as will be discussed in detail below.

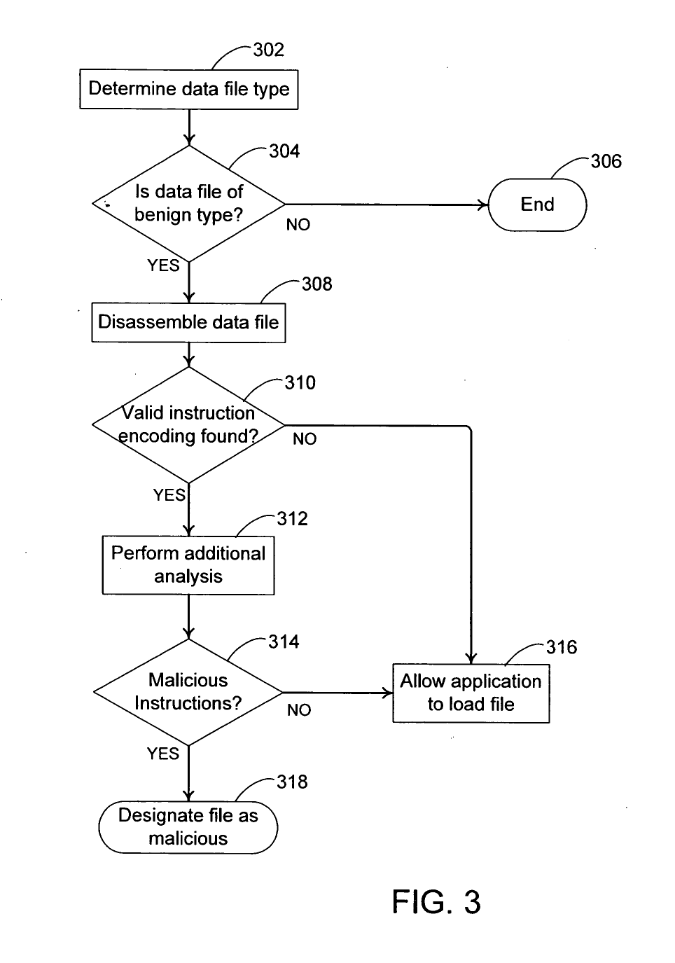

One exemplary embodiment of a two-stage method for detecting malicious code is illustrated in flowchart form in FIG. 3. It is noted that the method illustrated in FIG. 3 may be performed by malicious code detector 160. In step 302, the data file type is determined, for example, by examining the file extension portion of the name of the data file. In step 304 a discriminator that only allows benign data file types to be further processed is implemented. If the data file is not found to be a benign data type, then the method ends in step 306.

In a first detection stage, the benign data file type may be scanned for the presence of any binary encodings corresponding to a logical set of instructions. A logical set of instructions is a minimum defined set of consecutive instructions that make logical sense. In one instance, a logical set of instructions is defined by a reference table. In another case, a logical set is the presence of one or more instructions. If any encoding corresponding to a logical set of instructions is found in the benign data file type, then this serves as an indication that the file is at least suspicious, if not malicious. In this manner, all files that are not suspicious may be more easily and efficiently filtered, and allowed for further processing, storage, transmission as desired.

The first detection stage is implemented in steps 308 and 310 of FIG. 3. In step 308, where the data file is disassembled. In one case, disassembly represents a byte for byte searching of the binary content of the data file. In other embodiments, various other methods for disassembling binary data may be implemented in step 308.

In step 310, a determination is made if any encodings corresponding to instructions of executable machine code have been detected in the data file, which could render the data file suspicious for containing malicious code. In one embodiment, the determination step 310 may be combined with the disassembly step 308, for example by terminating as soon as a valid encoded instruction, or a logical set of instructions as described above, is detected. The encoded machine code instructions may include operational codes, (representing individual commands) and their respective operands. In other embodiments, various specific implementations of individual method steps, or combinations of steps, for ascertaining that a data file is suspicious, i.e., potentially malicious, may be adopted for the first stage.

If in step 310 no encoding corresponding to machine code is found, then the method continues to step 316, where the application may be allowed to load the file. In various embodiments, as discussed above, step 316 may be replaced with or include other actions related to normal processing of the data file, such as informing a user of the result, certifying the file as clean, recording the performing of the scan, transferring the file over the network, etc. In one embodiment, a file that is not found to be suspicious (or malicious) according to the methods described herein may be certified as a benign data file.

The positive determination in step 310 marks the begin of the second stage, which may include a further, more rigorous analysis of the suspicious data file for determining if an indication of maliciousness is present in the file. Since the second stage may involve analyses that are more extensive and specific to a given situation (i.e., the combination of platform, system, application, network, microprocessor, etc.), the processing required in the second stage may consume more resources, such as time and computing power. Therefore, performing the second, more detailed stage only on suspicious data files detected in the first stage may improve the overall efficiency of the method. Other methods that divide the detection procedure between the first and second stages, or combine them in a single unified operation, may also be practiced in various embodiments.

As mentioned above, if an encoding corresponding to machine code is found in step 310, then the file may be considered suspicious. In this case, an additional analysis may be conducted in step 312. The analysis in step 312 may be a more detailed and specific analysis according to various embodiments of the described methods. For example, the detected logical sets of instructions may be compared with a reference table of machine code instructions, to determine if the code is malicious. The additional analyses in step 312 may also or alternatively ascertain whether a detected logical set of instructions would result in either a control transfer (like jmp, jz, call, etc.) or an invocation of an operating system API procedure, when executed by a microprocessor. The presence of encoding found in a benign file type corresponding to such logically executable code sections may indicate that, if execution control were to be transferred to this location in the file, then an exploit could be triggered. If such a potential result is indicated, then the suspicion level of the data file may be further raised to malicious.

The detected sets of instructions may or may not be complete exploit code and may refer to further code sections for loading additional machine code instructions required for the exploit to exhibit actual malicious behavior. However, a detailed analysis of such subsequent code sections is not necessarily required for detecting the exploit. In many cases of exploits discovered so far (e.g., for WMF vulnerability, JPEG vulnerability etc.), it has been found that the initially detected section of instructions completely contained the exploit code. It is noted that even if the malicious code is polymorphic, it could still be detected from encodings corresponding to any logical set of instructions, which are an inherent anomaly in a benign data file type. In one embodiment, detection of maliciousness may be optimized by accommodating a certain spatial coherency of the machine code instructions during a search of the entire file at a binary level. When encodings corresponding to a logically significant set of instructions are found at a location in the data file, a section before and after that location may be marked for further scrutiny.

Other attributes of the executable code may be determined and evaluated for their respective maliciousness. The analysis in step 312 may depend in complexity and duration upon the results of previous steps in the analysis, such as the number of encoded instructions found in step 310.

The method of FIG. 3 may continue to step 314, where a decision may be made whether the executable code detected in the data file represents an exploit. If the decision in step 314 is no, then the method may continue to step 316, as described above, and effectively release the file for further processing. In this case, the file may also be registered or certified as having been scanned clean.

If in step 314 the decision is yes, the data file can be considered malicious and found to contain a serious threat of an exploit. In step 318, the file may be designated as malicious and thus subject to any action appropriate for malicious files, depending on the administration of the host system. Such actions may include quarantine, deletion, or destruction in the form of total erasure. The actions may also include user notification and acknowledgement of the status and specific malicious content found in the data file. Other actions commensurate with the handling of files containing a detected exploit may be performed in result of step 318, in various embodiments.

An additional result of step 314 may be the discovery and recording of newly discovered machine code instructions, either malicious or not malicious, that were detected in the data file. These newly discovered machine code instructions may be added to a reference table or some other body of knowledge, for example, to provide faster indication for future iterations of analysis 312 of potential maliciousness, if the same code instructions are detected again. Thus the method shown in FIG. 3 may include some cumulative capability to learn and adapt to exploits as they evolve over time.

In addition to the aspect of a two stage analysis, as shown in FIG. 3, there are many other ways of reducing or limiting the processing overhead for the detection methods described herein in various embodiments. For example, processing overhead may be brought within tolerable limits by implementing any one or more of the following:

1. Restrict file type—As previously mentioned, the type of data files considered suitable (for example, benign type data files) for the detection methods described herein may be restricted. In one embodiment, only file types that are possibly loaded by certain applications for viewing and processing are selected.

2. Check files on the basis of application association and known application vulnerability—If a vulnerability has been found or disclosed in a given application, then the detection for malicious code may be further restricted to only those files that can be processed by a vulnerable application.

3. Check files on the basis of source vector/origin—If the file has arrived on the host via more reliable mediums like CD/Floppy the priority awarded to such files as compared to files that arrive via network transport could be raised or lowered, as required. In one example, data files hosted on an intranet network shared location are deemed less suspicious than files downloaded via the Internet.

4. Check files on the basis of age—Newer files created after a certain date may be more suspect than older files. The duration a file has been resident on the system relative to how many times it has been opened or accessed may provide a further indication of suspiciousness. For example, if the file has been residing on the system for long but has so far never been accessed/opened, it its more suspect than files that have previously been accessed.

5. Check streaming content by delayed buffering—In order to perform the detection on streaming content, a scan may be performed in the buffering logic such that the hosting application can only read sections that have been scanned clean.

6. Check files in transit at network layer—Any of the above mentioned checks being performed on the host system may be implemented as scans at the network level, only limited by the computing power of the network component and the rate of data in transit. In one embodiment, the detection method is implemented in an FPGA processing unit that is a component in a network device. The network device may be any device involved with the transmission of data files across a network. In the FPGA implementation, the detection procedure may be updated over a network interface to the FPGA from a remote location, which may also include updating the reference table of known logical sets of machine code instructions.

7. Check files in transit at gateway level—In applications such as email, FTP, file share etc. the detection methods described herein may be performed on a server before the files are made available for download to other users and clients. Other methods and restrictions may be applied for optimizing the performance of detection procedures in various embodiments.

It is noted that some key benefits of the approaches described above include the ability to detect malicious code irrespective of the fact that the target application (i.e., the application program that is going to load or process the file) is vulnerable or patched. Also in some cases embodiments of the described methods may detect both the malicious code and an unknown or undisclosed vulnerability in a target application. By detecting the malicious code, the mechanism of an undiscovered vulnerability in an application program may be documented, and may thus provide a basis for patching the vulnerability to that exploit.

It is further noted that any of the embodiments described above may further include receiving, sending or storing instructions and/or data that implement the operations described above in conjunction with FIGS. 1-3 upon a computer readable medium. Generally speaking, a computer readable medium may include storage media or memory media such as magnetic or optical media, e.g. disk or CD-ROM, volatile or non-volatile media such as RAM (e.g. SDRAM, DDR SDRAM, RDRAM, SRAM, etc.), ROM, etc. as well as transmission media or signals such as electrical, electromagnetic, or digital signals conveyed via a communication medium such as network and/or a wireless link.

The embodiments described herein may also be implemented by an information handling system comprising a memory, a first processor, and computer-readable code stored on said memory and processable by said first processor. A system implementing the methods described herein may be configured in various embodiments to perform a detection scan in real-time, with fixed scan periods, in response to an event (such as receiving a data file), or may be scheduled to work in the background at periodic intervals.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method for detecting malicious code comprising:
disassembling a data file, wherein the data file is a benign type of data file, wherein the disassembling includes searching said data file for one or more encodings corresponding to executable code; and
designating the data file as suspicious in response to detecting one or more encodings corresponding to executable code in the data file.

2. The method of claim 1, further comprising:
making a determination whether the one or more encodings corresponding to executable code would result in a transfer of process control when executed; and
designating the data file as malicious in response to said determination being positive.

3. The method of claim 1, wherein the benign type of data file includes any one of:
JPEG files;
WMF files;
HTML files;
text files;
audio data files;
image data files;
video data files; and
any type of data file whose format does not specify the inclusion of executable code.

4. The method of claim 2, wherein the one or more encodings corresponding to executable code include machine code instructions for causing a microprocessor to perform any one of:
load a variable;
jump to a register;
jump to a location in memory;
jump to an instruction;
generate an interrupt;
call a procedure;
switch to a different task; and
invoke any operating system API procedure.

5. The method of claim 1, wherein the one or more encodings corresponding to executable code includes one or more operational codes of a microprocessor.

6. The method of claim 5, wherein the operational codes include operands associated with operational codes of a microprocessor.

7. The method of claim 2, wherein the one or more encodings corresponding to executable code include one or more machine code instructions detected by matching one or more entries in a reference table of machine code instructions.

8. An information handling system comprising:
a memory;
a first processor; and
computer-readable code stored on said memory and processable by said first processor for implementing detection of malicious code, said computer-readable code including instructions for causing said first processor to:
disassemble a data file, wherein the data file is a benign type of data file, wherein the disassembling includes searching said data file for one or more encodings corresponding to executable code; and
designate the data file as suspicious in response to detecting one or more encodings corresponding to executable code in the data file.

9. The system of claim 8, further includes instructions for causing said first processor to:
make a determination whether the one or more encodings corresponding to executable code would result in a transfer of process control when executed; and
designate the data file as malicious in response to said determination being positive.

10. The system of claim 8, wherein the benign type of data file includes any one of:
JPEG files;
WMF files;
HTML files;
text files;
audio data files;
image data files;
video data files; and
any data file whose format does not specify the inclusion of executable code.

11. The system of claim 8, wherein the one or more encodings corresponding to executable code include machine code instructions for causing a second microprocessor to perform any one of:
load a variable;
jump to a register;
jump to a location in memory;
jump to an instruction;
generate an interrupt;
call a procedure;
switch to a different task; and
invoke any operating system API procedure.

12. The system of claim 8, wherein the one or more encodings corresponding to executable code include one or more operational codes of a second microprocessor.

13. The system of claim 12, wherein said first processor and said second microprocessor are the same processor.

14. The system of claim 9, wherein the one or more encodings corresponding to executable code include one or more machine code instructions detected by matching one or more entries in a reference table of machine code instructions.

15. The system of claim 8, wherein said first processor is implemented as an embedded controller in a network device, wherein the data file is disassembled from a stream of network packets representing the data file in transit.

16. A computer readable medium for implementing a method for detecting malicious code, including program instructions executable to:
disassemble a data file, wherein the data file is a benign type of data file, wherein the disassembling includes searching said data file for one or more encodings corresponding to executable code; and
designate the data file as suspicious in response to detecting one or more encodings corresponding to executable code in the data file.

17. The computer readable medium of claim 16, further including program instructions executable to:
make a determination whether the one or more encodings corresponding to executable code would result in a transfer of process control when executed; and
designate the data file as malicious in response to said determination being positive.

18. The computer readable medium of claim 16, wherein the benign type of data file includes any one of:
JPEG files;
WMF files;
HTML files;
text files;
audio data files;
image data files;
video data files; and
any data file whose format does not specify the inclusion of executable code.

19. The computer readable medium of claim 17, wherein the one or more encodings corresponding to executable code include machine code instructions for causing a microprocessor to perform any one of:
load a variable;
jump to a register;
jump to a location in memory;
jump to an instruction;
generate an interrupt;
call a procedure;
switch to a different task; and
invoke any operating system API procedure.

20. The computer readable medium of claim 17, wherein the one or more encodings corresponding to executable code include one or more machine code instructions detected by matching one or more entries in a reference table of machine code instructions.
